(19) United States
(12) Patent Application Publication
(10) Pub. No.: US 2021/0031329 A1
(43) Pub. Date: Feb. 4, 2021

(54) MACHINING DEVICE HAVING A VIBRATION-DAMPING DEVICE, AND METHOD

(71) Applicant: HOMAG GmbH, Schopfloch (DE)

(72) Inventors: Christian STURM, Nagold (DE); Philipp SEKINGER, Aichhalden (DE)

(21) Appl. No.: 16/306,888

(22) PCT Filed: Jun. 8, 2017
(86) PCT No.: PCT/EP2017/063955

§ 371 Date: Dec. 3, 2018

(30) Foreign Application Priority Data
Jun. 9, 2016 (DE) 102016210233.8

(51) Int. Cl. B24B 41/00

(52) U.S. Cl. CPC B24B 41/007

(57) ABSTRACT

The invention relates to a machining device (1), in particular a CNC machining device, for machining preferably planar workpieces (W) that are preferably composed of wood, wood material, plastic, and/or glass at least in parts, comprising: a machining assembly, which has a dynamic element; a first guide assembly, by means of which the machining assembly can be moved in a spatial direction; and at least one vibration-damping device. Vibrations of the dynamic element (3) can be passively damped by means of the at least one vibration damper device.

### FIELD OF THE INVENTION

The invention relates to a machining device, in particular a CNC machining device, for machining preferably plate-shaped workpieces, as well as a method.

### PRIOR ART

Nowadays in the field of machining devices, a plurality of different machining possibilities must be must be offered and performed. I.e. the requirements placed on machining devices is often a split between machining processes in which a relatively small tool with a relatively high rotational speed is operated on the one hand, and on the other hand, machining processes in which a relatively large tool having a large mass and a large tool diameter is operated at a low rotational speed. For the small tools, a tool holding fixture is required which can be operated at very high rotational speeds (for example, 24,000 min−1). By contrast, for large tools, a high rigidity of the tool holding fixture is required which can absorb process forces such as, for example, bending torque, radial forces, cutting forces, etc. which are commonly very large at low rotational speeds. Since tool holding fixtures for high rotational speeds and tool holding fixtures for high process forces are generally dimensioned differently, there is a target conflict which means that the respective requirements can only be taken into account unsatisfactorily within the framework of compromise solutions. Additionally, the tools used are always becoming more powerful which, on the one hand, makes it possible to increase the rotational speed with even large tools having high process forces, yet on the other hand, this leads to the demands on the machining device increasing, in particular, with regard to resulting vibrations.

Accordingly, with known machining devices there is the problem that the tool holding fixture or the machining aggregate cannot be optimally designed for every tool, and accordingly, unwanted vibrations can occur in the tool holding fixture when machining a workpiece, in particular vibrations corresponding to the natural mode of the basic machine. This is particularly problematic with CNC machining devices in which the machining aggregate including the tool holding fixture is often suspended from multi-axis linear guides, which reduces the rigidity of the suspension and enables the vibrations generated to resonate up to a machine frame, in particular up to a machine bed of the machining device. This leads to an increased stress on the CNC machining device as well as the tool, and reduces the machining quality. The same problem applies to conventional pass-through machines since performance requirements also constantly increase with these.

For this reason, there is an effort to provide vibration-damping devices for machining devices, in particular for machining aggregates of CNC machining devices.

There are similar problems in the field of printing technology, textiles technology or newspaper press technology in which vibrations occur owing to the high rotational speed of, for example, pressure rollers or deflection shafts which can lead to damage to the bearings in the event of an superpositioning with the natural frequency. DE 10,2008,050,989 A1 therefore teaches, for example, to use a damped absorber to reduce vibrations of a hollow machine part such as a shaft, a roller or a mandrel. The damped absorber is composed of an additional mass and a damping and an elastic element. The additional mass is surrounded by a damping and elastic cylinder-shaped layer. In order to achieve the required parameters such as rigidity and damping coefficient with a predetermined additional mass and a certain main system, a defined pressure must be exerted on the elastic and damping layer. This makes a particular construction necessary which allows the absorber to integrate into a cylinder-shaped main system, such as for example, a mandrel.

Furthermore, active vibration-damping systems that are installed in the tool holding fixture are known from the field of machine tools. In the known active vibration-damping systems, the vibration amplitude of a vibration generated during the machining of a workpiece is detected by means of an acceleration sensor directly attached to the tool holding fixture, and a counter pulse corresponding to the detected vibration amplitude is generated by means of an electrodynamic actuator. However, this requires for each spatial direction in which the one vibration compensation is supposed to occur, the installation of an acceleration sensor as well as an electron-dynamic actuator, as well as the provision of a complicated controller for vibration compensation. This leads to high acquisition costs for such a type of vibration-damping system, which in many cases makes it economically uninteresting. Furthermore, the use is limited to larger machining devices due to the necessary actuators since otherwise the dead weight of the actuators influences the inertia mass of the machining aggregate too much.

### DESCRIPTION OF THE INVENTION

The object of the present invention is therefore to provide a machining device, in particular a CNC machining device for machining preferably plate-shaped workpieces, with which the vibrations on a machining aggregate can be cost-effectively damped by means of a simple design.

The object is solved by a machining device according to claim 1 as well as a method according to claim 12. Preferred further developments of the invention are given in the dependent claims.

One of the core ideas of the present invention is to passively damp, in particular to absorb and to passively damp, vibrations of a dynamic element of a machining aggregate, in particular of a rotating tool spindle, which occur during the machining of a workpiece, by means of a vibration-damping device.

Using the proposed vibration-damping device, it is possible by means of a simple device design to passively damp the vibrations of a dynamic element of a machining aggregate, in particular of a rotating tool spindle, which occur during the machining of a workpiece, in a cost-effective manner. This eliminates the need for complicated control of an active damping element and the sensors and actuators needed for this, drastically reducing the manufacturing cost of the proposed vibration-damping device compared to known systems as well as the complexity.

According to the present invention, the machining device, in particular the CNC machining device for processing preferably plate-shaped workpieces which are preferably made at least in sections of wood, wood material, synthetic material and/or glass, has a machining aggregate with a dynamic element which preferably comprises a rotating tool spindle, a first guide assembly by means of which the machining aggregate can be moved in at least one spatial direction, and at least one vibration-damping device, wherein by means of the at least one vibration-damping device, vibrations of the dynamic element can be passively damped. The workpieces to be machined can also be rod-shaped or cubic workpieces as well as free-form bodies and the like.

In this manner, a vibration-damping device is provided with which, for example, with a CNC machining device as a specific example of a machining device, in a simple and cost-effective manner, vibrations of a dynamic element, in particular of the tool spindle of the machining aggregate of the CNC machining device, which occur in particular during the machining of a workpiece can be passively damped.

According to one embodiment of the present invention, the at least one vibration-damping device is provided on the side of the guide assembly facing the dynamic element or on the first guide assembly itself.

The vibration damping device provided thereby is particularly capable of damping the vibrations as closely as possible to the point of origin of the vibrations. Owing to the fact that the vibration-damping assembly is provided on the side of the first guide assembly facing the dynamic element, vibrations occurring can be damped even before reaching the first guide assembly. This prevents the propagation of vibrations and the associated vibration due to resonance.

According to an embodiment of the present invention, the at least one vibration-damping device of the machining device preferably is a vibration-absorbing device (damped absorber) which comprises at least one damping element, one auxiliary mass, and one elastic support member. This makes it possible not only to damp the dynamic element passively, but also to absorb and passively damp the resulting vibrations.

Here the elastic support element can carry the at least one damping element and the auxiliary mass, with preferably the elastic support member being fastened directly to the dynamic element or to the first guide plane. It is also possible to attach the at least one damping element to the auxiliary mass.

In general, passive vibration dampers/absorbers are known from the field of skyscraper and bridge construction such as, for example, the Millennium Bridge in London, the Rhine Bridge in Kehl-Strasbourg, as well as the skyscraper Taipei 101 in Taiwan. In principle, a damping element is accommodated in an elastic support member (for example, a housing) and is positioned to a dynamic element (for example, high-rise building). The damping element thereby remains in position and does not resonate with the critical frequency of the dynamic element (for example, the vibration of a high-rise building in the event of an earthquake), the elastic support member is equipped with a correspondingly large auxiliary mass. This auxiliary mass causes the elastic support member together with the damping element to remain in its intended position due to the inertia of the auxiliary mass, and accordingly enables the damping element to exert a damping force (damping effect) on the dynamic element. Specifically, this means that the dynamic element (also called vibration exciter) vibrates at a relatively high critical frequency within the elastic support member, whilst the elastic support member including the auxiliary mass vibrates with a relatively low frequency without becoming excited by the critical frequency.

If the elastic support member is secured directly to the dynamic element, it is necessary that the elastic support member has a sufficiently high elasticity to prevent an excitation of the auxiliary mass at the critical frequency of the dynamic element. However, there is the possibility thereby of arranging the vibration-damping device very compactly and very close to the point of origin of the vibrations. This makes it possible to damp the resulting vibrations before they propagate over wide areas of the machining device and, possibly, an increase in vibration builds up due to resonance. Since, as a rule, the connection between machining aggregate and guide assembly is formed extremely rigidly, a sufficiently high elasticity of the support member is also required in a case when the elastic support element is secured to the guide assembly.

Preferably the damping force of the at least one damping element directly acts on the dynamic element or the damping force of the at least one damping element indirectly acts on the dynamic element. Indirect in this context means that the at least one damping element acts, for example, on a suspension part by means of which the dynamic damping element or the machining aggregate comprising the dynamic damping element is fastened to the guide assembly. I.e. the damping force of the at least one damping element, for example, engages the suspension part and thus indirectly damps the vibration of the dynamic element.

According to one preferred embodiment of the present invention, the at least one damping element can be configured in the form of a hydraulic shock absorber, a mechanical shock absorber, an eddy-current damper, an electro-mechanical converter material, a hydraulic damping gap or the like. Individual types will be discussed more specifically below.

Moreover, the first guide assembly can comprise a guide device which is preferably configured in the form of a linear guide. The guide device can thereby have a guide carriage to which the machining aggregate including the dynamic element is secured in order to moveably guide the machining aggregate in a spatial direction, with the spatial direction being anywhere in space. Such guide devices are used, in particular, with CNC machining devices as well as pass-through machines in order to preferably be able to move the tool in all three spatial directions. However, guide devices have the disadvantage of reducing the rigidity of the suspension of the machining aggregate which makes the suspension more susceptible to vibrations, especially the build-up of increased vibrations. Since the vibration-damping device according to the present embodiment is, however, on the side of the guide assembly facing the dynamic element, the vibrations can be absorbed and damped before they reach the guide assembly.

According to the present invention, there is also the possibility to provide the vibration-damping device on the guide carriage of the guide device with which the vibration-damping device is still on the side of the guide device facing the dynamic element. By contrast, guide rails of the guide device and a machine frame to which, for example, the guide rails are attached, are arranged on the side of the guide device facing away from the dynamic element. Due to this assembly, it is possible to bring the center of mass of the vibration-damping device closer to the guide device and to consequently influence the inertia of the machining aggregate less. However, on the other hand, the critical vibrations of the dynamic element can only be damped indirectly since the damping force of the at least one damping element does not directly engage the dynamic element.

According to one further preferred embodiment of the present invention, it is possible to integrate the vibration-damping device into the tool spindle of the machining aggregate. Therefore, using this configuration, the vibration-damping device is directly built into the dynamic element. In this case, the tool spindle has a cylinder-shaped inner part and a hollow cylinder-shaped outer part, with the outer part being mounted on the inner part. With this design, the cylinder-shaped inner part corresponds to the dynamic element (vibration exciter) and the hollow cylinder-shaped outer part to the auxiliary mass and contains the damping element. Owing to the usually limited installation space, the design of the damping element in the form of a hydraulic damping gap is therefore ideal.

Moreover, it is preferred that the mass of the auxiliary mass and/or the damping characteristic of the damping element and/or the rigidity of the elastic support member is/are adjustable. It is particularly preferred that the respective adjustment is adjustable corresponding to the machining parameters such as, for example, feed rate, cutting speed, cutting depth, cutting force, rotational speed of the tool, and/or type of tool used, and/or measured vibration data, etc. This offers the advantage that the absorption and passive damping can be optimally adjusted to the occurring vibrations, in particular the adjustment can be made in such a way that a closer frequency range around the natural mode of the basic machine is particularly damped, whereby a resonance with the natural mode of the basic machine can be avoided. The basic machine is to be understood as the part of the machine which is located on the side of the guide assembly facing away from the dynamic element. The adjustment can thereby occur manually, mechanically or motorized. In particular as regards the adjustment of the damping characteristics of the damping element, the use of an eddy-current damper or an electro-mechanical converter material is ideal, since its damping force is purely electro-mechanically adjustable. The damping characteristic is to be understood as the applicable damping force, the damping constant (how fast the damper can follow the vibration), linear or progressive dampers and the like.

It is further preferred that at least two vibration-damping devices are provided which have two different directions of action that are on a shared plane. The vibration-damping devices are particularly preferably arranged around the dynamic element, which enables a compact design. If the machining device is provided with two vibration-damping devices which act on a shared plane in different directions, it is possible to damp the occurring vibrations in two spatial directions, which in sum increases the damping effect, especially if the direction of the occurring vibration amplitudes changes due to machining parameters.

According to a further preferred embodiment, the machining device is provided with three vibration-damping devices which have three different directions of action, and are on two intersecting planes. Furthermore, particularly preferably the three vibration-damping devices are arranged around the dynamic element.

In this manner, it is possible to damp vibrations occurring in three spatial directions.

Moreover, the present invention relates to a method for operating a machining device, in particular for operating a machining device as described above, wherein by means of the method, vibrations of a dynamic element of a machining aggregate, which in particular comprises a rotating tool spindle, which arise or occur during the machining of a workpiece, are passively damped, in particular absorbed and passively damped, by means of a vibration-damping device.

According to one preferred embodiment of the present invention, the method further comprises: determining machining parameters such as, for example, feed speed, cutting speed, cutting depth, cutting force, rotational speed of the tool, tool type, etc., and/or determining vibrations occurring from the dynamic element, preferably by means of vibration sensors, determining optimal setting parameters of the vibration-damping device such as, for example, the mass of the auxiliary mass, damping characteristics of the damping element, rigidity of the elastic support member, etc. and adjusting the optimal setting parameters of the vibration-damping device.

The determining of the optimal setting parameters of the vibration-damping device can thereby occur based on the determined machining parameters and/or the determined occurring vibrations, with preferably the determined machining parameters and/or the determined occurring vibrations being compared to empirically determined values and/or compared to values determined by means of simulations, and determined corresponding to the optimal setting parameters.

In this way, for example, the critical frequency, the natural frequency (natural mode) of the basic machine, can be determined which is largely constant regardless of the respective tool used and the respective machining parameters. Subsequently, different tools can be operated at different machining parameters in adjustment mode and the resulting vibrations can be measured in the test setup. In accordance with the measured vibrations, optimal setting parameters can then be detected and tested. The determined, optimal setting parameters can then be stored in a database which a standard machine can access, taking into account the tool used and the respective machining parameters, and corresponding to the setting parameters (such as, for example, mass of the auxiliary mass, damping characteristics of the damping element, rigidity of the elastic support member), the vibration-damping device can be automatically adjusted.

The adjustment of the optimal setting parameters can thereby preferably be carried out manually, motorized or electro-mechanically.

### BRIEF DESCRIPTION OF THE DRAWINGS

FIG. 1 schematically shows the basic principle of a vibration absorber damping system according to an embodiment of the present invention,

FIG. 2 shows a perspective representation of one embodiment of a machining aggregate of a machining device according to the present invention,

FIG. 3 schematically shows a first embodiment of a vibration-damping device for a machining device according to the present invention,

FIG. 4 schematically shows a second embodiment of a vibration-damping device for a machining device according to the present invention,

FIG. 5 schematically shows a third embodiment of a vibration-damping device for a machining device according to the present invention, and

FIG. 6 schematically shows a fourth embodiment of a vibration-damping device for a machining device according to the present invention.

### DETAILED DESCRIPTION OF THE PREFERRED EMBODIMENTS

In the following, preferred embodiments of the present invention are described with reference to the accompanying drawings. Further variants and modifications of individual features cited in this context can each be combined with one another in order to form new embodiments.

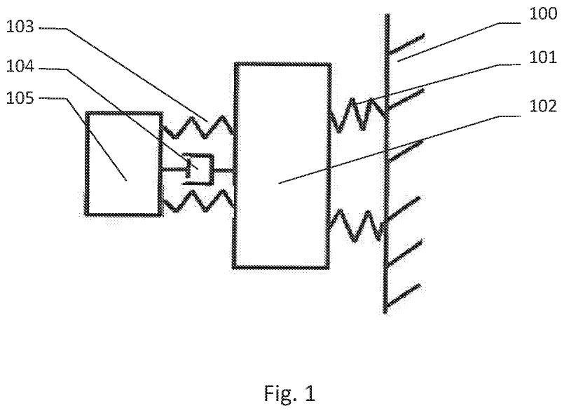

FIG. 1 schematically shows the basic principle of a vibration absorber damping system according to an embodiment of the present invention. In FIG. 1, the reference number (100) represents the first guide assembly (5) which is shown as a static element to simplify the illustration. A swinging mass (102) is elastically suspended on the rigid element (100). The elastic elements (101) thereby correspond to the existing elasticity of the suspension of the mass (102). The mass (102) corresponds to the dynamic element (3) or the vibration exciter. At the vibrating mass (102), an auxiliary mass damper (HMD) or a vibration absorber/damping system according to the present invention is provided. The vibration absorber/damping system has an auxiliary mass (105) which is secured to the vibrating mass (102) by means of an elastic element (103), corresponds to the support member (9). Furthermore, the vibration absorber/damping system has a damper (104) which corresponds to the damping elements (7). The spring constant of the elasticity (101) is considerably higher than the spring constant of the elastic element (103). Consequently, the mass (102) is relatively rigidly secured to the static element (100) and on the other hand, the auxiliary mass (105) is relatively softly secured to the vibrating mass (102) by which the auxiliary mass (105) can be decoupled from the critical vibrations (frequencies) of the vibrating mass (102). Accordingly, the damper (104) stays at its place when viewed relative to the vibrating mass (102), and can thereby exert a damping force onto the vibrating mass (102).

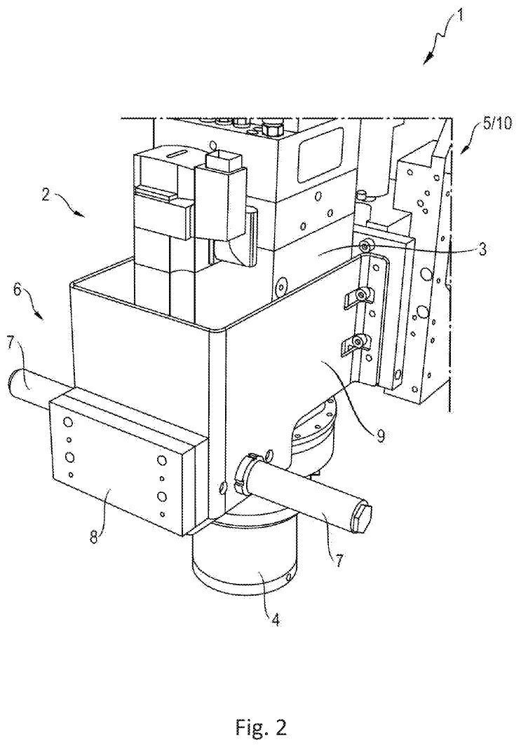

FIG. 2 shows a perspective representation of one embodiment of a machining aggregate of a machining device according to the present invention. In the following, an embodiment of the present invention is described by way of example using a CNC machining device as a specific example of a machining device. As already mentioned previously, this can also, however, be machining aggregates of other machining devices such as, for example, pass-through machines. As shown, a machining device (1) generally has a machining aggregate (2) which comprises a tool spindle (4) which can accommodate a desired tool such as, for example, a milling tool, a drill, a sanding head, etc. The assembly of the machining aggregate (2) which rotatably accommodates and comprises the tool spindle (4) is called dynamic element (3) below since this assembly is significantly responsible for the generation and introduction of vibrations into the machining device (1). The dynamic element (3) is also often designated as a vibration exciter.

Vibrations can be caused by the rotation of the tool spindle (4) together with the tool, for example, due to an unbalance at the tool spindle (4) or the tool owing to changing loads on the tool during the machining of a workpiece and the like.

As is also revealed by FIG. 1, the CNC machining device has a first guide assembly (5) to which the machining aggregate (2) is secured and by means of which the machining aggregate can be moved in a spatial direction. The shown guide assembly (5) is referred to as the “first guide assembly” since the machining aggregate is directly secured to it without the interposition of a further guide assembly. As a rule, the first guide assembly (5) carries out a vertical movement, which allows the tool to be advanced to the workpiece to be machined. In the shown embodiment example, the dynamic element (3) comprises the tool spindle (4), a bearing of the tool spindle, a gear and a drive unit. The vibration-damping device (6) is realized such that the elastic support member (9) is configured in the form of a holding bracket which surrounds the dynamic element (3) in the horizontal plane and is secured to a guide carriage (11) of the guide assembly (5). Since the holding bracket is only formed using a thin sheet without any reinforcements, the holding bracket (elastic support member (9)) has a sufficiently high elasticity in order to largely decouple from the dynamic element (3), the auxiliary mass (8) which is arranged at the front side of the holding bracket centrally to the dynamic element (3). I.e., a propagation of the critical vibrations of the dynamic element (3) to the auxiliary mass (8) is prevented as best as possible. However, when determining the elasticity of the elastic support member (9) a compromise must, however, be found between sufficiently high elasticity for vibration decoupling dynamic element (3)—auxiliary mass (8), and a sufficiently high rigidity of the elastic support member (9) to suppress a reverberation of the elements of the vibration-damping device (9) during the movement (acceleration-braking) of the machining aggregate. Therefore, there is also the possibility to form the holding bracket more rigidly and to instead provide an elastic element for vibration decoupling between the holder console and the guide carriage. The critical vibration (critical frequency) is understood to be the natural frequency of the basic machine (e.g. base frame with guide assemblies) under which a resonance could occur in the basic machine and thus an increase in vibration could build up in the basic machine.

The auxiliary mass (8) is constructed modularly, i.e. the auxiliary mass (8) consists of individual weight plates that can be modularly secured to the holding bracket in order to adjust the mass of the auxiliary mass in accordance with the operating parameters and/or the measured vibration data.

In the embodiment shown in FIG. 1, only one vibration-damping device (6) with a horizontal direction of action is provided. I.e. the damping elements (7) of the vibration-damping device (6) act in the horizontal direction. As shown in FIG. 1, the exemplary vibration-damping device (6) has two damping elements (7) provided on two opposite sides of the holding bracket and thus exert a damping force on the dynamic element (3) from two opposite directions.

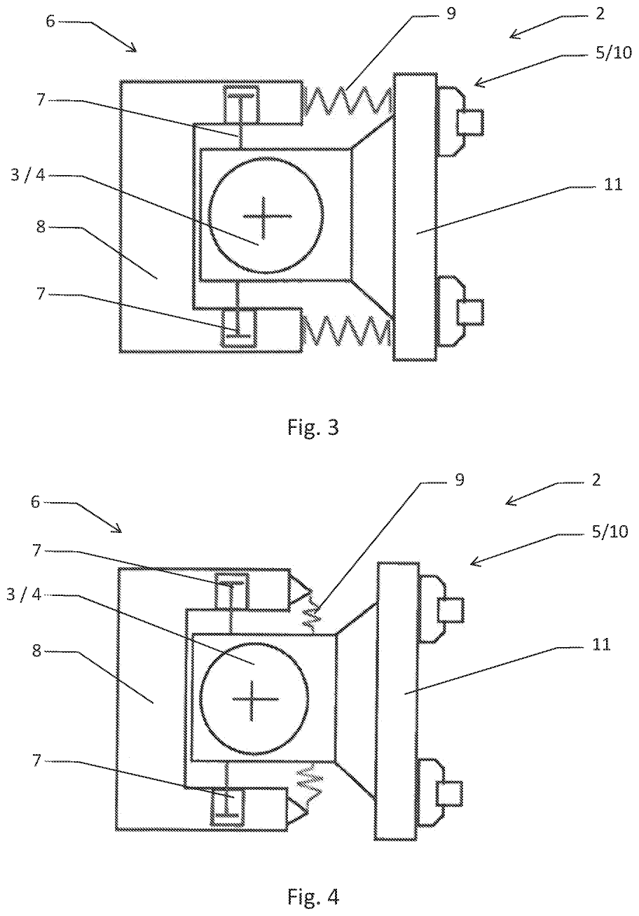

In the following, different embodiments of the vibration-damping device (6) of the present invention in its basic structure will be explained by means of schematic illustrations that are shown in FIGS. 3 to 6.

FIG. 3 schematically shows essentially the same design as already described in detail in FIG. 1. In this embodiment, the elastic support member (9) is attached to the guide carriage (11) of the guide assembly (5) and decouples the auxiliary mass (8) from the dynamic element (3). As shown in FIG. 2, it is also possible to directly secure the damping elements (7) to the auxiliary mass (8) or to mount them in it. The damping elements (7) can engage each component of the dynamic element (3) (vibration exciter), with it being preferred that the damping elements (7) directly engage on the bearing of the tool spindle in order to form the passive damping even more directly.

FIG. 4 shows a further embodiment of the vibration-damping device (6) according to the present invention. In this embodiment, in contrast to the embodiment shown in FIG. 3, the elastic support member (9) is directly secured to the dynamic element (3) which enables a more compact construction, yet a decoupling of the auxiliary mass (8) from the critical vibrations of the dynamic element (3) is made more difficult.

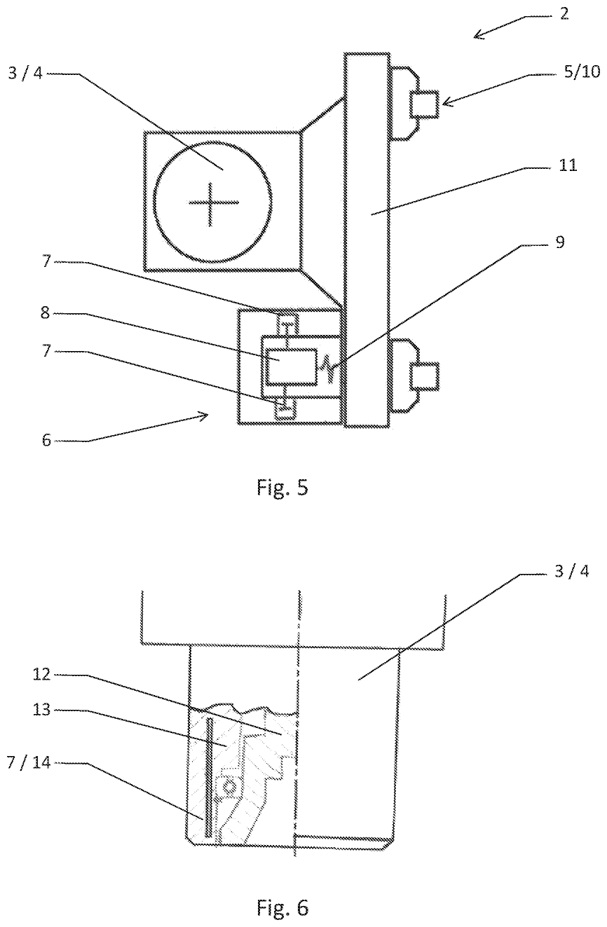

FIG. 5 shows another embodiment of the vibration-damping device (6). In the present case, the vibration-damping device (6) is not formed around the dynamic element (3) as in the above-described embodiments which enables the damping forces of the damping elements (7) to directly engage the dynamic element (3), but rather it is entirely integrated or built on to the guide carriage (11). As revealed by FIG. 5, this offers the advantage that the vibration-damping device can be formed extremely compactly. Further, the decoupling of the auxiliary mass (8) from the critical vibrations of the dynamic element (3) is relatively simple. As shown, in this case, the auxiliary mass (8) can be arranged vibrating between the two damping elements (7) and fixed to the guide carriage (11) only by means of the elastic support member (9). In turn, the damping elements (7) are connected with the guide carriage by means of a receiving bracket and thereby indirectly damp critical vibrations of the dynamic element (3) before they propagate to other components of the machining device (basic machine).

In turn, FIG. 6 shows another embodiment of the vibration-damping device (6) of the present invention. As is visible from FIG. 6, in accordance with this embodiment, the vibration-damping device (6) can be completely integrated into the dynamic element (3), in particular directly into the tool spindle (4). The tool spindle (4) is thereby formed from two elements, a cylinder-shaped inner part (12) and a hollow cylinder-shaped outer part (13), with the outer part (13) being mounted on the inner part (12) and corresponds to the auxiliary mass (8). As shown, the damping element (7) or the damping elements (7) are integrated into the outer part (13) preferably distributed equally in the circumferential direction at the outer part (13). Owing to the limited installation space, it is therefore ideal, as shown, to configure the damping element (7) in the form of a hydraulic damping gap. The damping gap has a damping effect due to fluid friction. Since the outer part (13) as well as the bearing of the outer part (13) on the inner part (12) is relatively soft, and the outer part (13) is weakened further by the hydraulic damping gap, the outer part (13) can easily deform elastically under vibration excitation by the inner part (12) whereby the fluid present in the damping gap is moved, and thereby performs friction work which dampens the occurring vibrations. Further with this embodiment, the outer part (13) can be provided with a reservoir (not shown) in which the provided fluid can be displaced in order to increase the moving amount of fluid and to thereby increase the damping performance. The hydraulic damping gap is preferably formed relatively narrow and long in order to encourage the fluid friction.

1. A machining device, in particular a CNC machining device for machining preferably plate-shaped workpieces which are preferably made at least in sections of wood, wood material, synthetic material and/or glass, comprising:
a machining aggregate having a dynamic element which preferably comprises a rotating tool spindle;
a first guide assembly by means of which the machining aggregate can be moved in a spatial direction; and
at least one vibration-damping device,
wherein by means of the at least one vibration-damping device, vibrations of the dynamic element can be passively damped.

2. The machining device according to claim 1, wherein the at least one vibration-damping device is provided on the side of the first guide assembly facing the dynamic element or on the first guide assembly.

3. The machining device according to claim 1, wherein the at least one vibration-damping device is configured in the form of a vibration-absorbing device which comprises at least one damping element, one auxiliary mass and one elastic support member.

4. The machining device according to claim 3, wherein the elastic support member carries the damping element and the auxiliary mass, the elastic support member preferably being directly secured to the dynamic element or to the first guide assembly.

5. The machining device according to claim 1, wherein the one damping force of the at least one damping element directly acts on the dynamic element or the damping force of the at least one damping element indirectly acts on the dynamic element.

6. The machining device according to claim 1, wherein the at least one damping element is a hydraulic shock absorber, a mechanical shock absorber, an eddy-current damper, an electro-mechanical converter material or a hydraulic damping gap.

7. The machining device according to claim 1, wherein the first guide assembly comprises a guide device which is preferably configured in the form of a linear guide, the guide device preferably comprising a guide assembly to which the machining aggregate is secured in order to be movable in a spatial direction, and the vibration-damping device being provided on the guide assembly.

8. The machining device according to claim 1 wherein the vibration-damping device is integrated into the tool spindle of the machining aggregate, the tool spindle having a cylinder-shaped inner part and a hollow cylinder-shaped outer part, the outer part being mounted on the inner part, the outer part corresponding to the auxiliary mass and containing the damping element, the damping element preferably being configured in the form of a hydraulic damping gap.

9. The machining device according to claim 1, wherein the one mass of the auxiliary mass and/or the damping characteristics of the damping element and/or a rigidity of the elastic support member is/are adjustable, in particular, corresponding to the present machining parameters and/or the tool used and/or the measured vibration data.

10. The machining device according to claim 1 wherein the at least two vibration-damping devices are provided which have two different directions of action which are on a shared plane, the two vibration-damping devices preferably being arranged around the dynamic element.

11. The machining device according to claim 1 wherein the three vibration-damping devices are provided which have three different directions of action and are on two intersecting planes, the three vibration-damping devices preferably being arranged around the dynamic element.

12. A method for operating a machining device, in particular the machining device according to claim 1, wherein by means of the method, vibrations of a dynamic element of a machining aggregate occurring during the machining of a workpiece are passively damped by means of a vibration-damping device.

13. The method according to claim 12, wherein the method further comprises:
determining machining parameters such as, for example, feeding speed, cutting speed, cutting depth, cutting force, rotational speed of the tool, type of tool, etc., and/or detecting vibrations occurring by the dynamic element, preferably by means of vibration sensors
detecting optimal setting parameters of the vibration-damping device such as, for example, the mass of the auxiliary mass, damping characteristics of the damping element, rigidity of the elastic support member, etc.; and
adjusting the optimal setting parameters of the vibration-damping device.

14. The method according to claim 13, wherein the determination of the optimal setting parameters of the vibration-damping device occurs on the basis of the determined machining parameters and/or the determined occurring vibrations, the determined machining parameters and/or the determined occurring vibrations preferably being compared with empirically determined values and/or values determined by means of simulations and being determined corresponding to the optimal setting parameters.

15. The method according to claim 13, wherein the adjustment of the optimal setting parameters occurs manually, motorized or electro-mechanically.
